(19) United States
(12) Patent Application Publication
(10) Pub. No.: US 2023/0080581 A1
(43) Pub. Date: Mar. 16, 2023

(54) EXPANDING FOAMS IN ADDITIVE MANUFACTURING

(71) Applicant: Intrepid Automation, San Diego, CA (US)

(72) Inventors: Ben Wynne, Escondido, CA (US); Madison Lee Stadtmueller, Encinitas, CA (US); Ivan Dejesus Chousal, Chula Vista, CA (US); Christopher Sean Tanner, Idyllwild, CA (US)

(73) Assignee: Intrepid Automation, San Diego, CA (US)

(21) Appl. No.: 17/930,120

(22) Filed: Sep. 7, 2022

Related U.S. Application Data
(60) Provisional application No. 63/261,135, filed on Sep. 13, 2021.

(51) Int. Cl. B29C 64/371; B29C 64/264; B29C 64/393; B29C 44/02; B29C 44/34; B29C 44/14

(52) U.S. Cl. CPC B29C 64/371; B29C 64/264; B29C 64/393; B29C 44/022; B29C 44/3403; B29C 44/146; B33Y 10/00

(57) ABSTRACT

Methods of creating additive manufactured parts from expanding foam material include printing a part made of an expandable foam, using an additive manufacturing system. The foam is printed in an unexpanded state and has a closed layer at an external surface of the part. Expansion of the part is controlled, using the additive manufacturing system, wherein the expansion is performed after the printing. Methods also include modeling an expansion of a part made of an expandable foam, and printing the part made of the expandable foam, using an automated additive manufacturing system and according to the modeling. The foam is printed in an unexpanded state and has a closed layer at an external surface of the part.

### RELATED APPLICATIONS

This application claims priority to U.S. Provisional Application No. 63/261,135, filed on Sep. 13, 2021, and entitled “Expanding Foams in Additive Manufacturing”; the contents of which are hereby incorporated by reference.

### BACKGROUND

Additive manufacturing (i.e., 3D printing) has become an extremely popular method for producing parts, from prototypes to commercial production. There are many types of additive manufacturing systems and methods that have been developed. Some types utilize a vat containing a photosensitive polymer (i.e., photopolymer), where layers of the 3D printed part are grown upon each other within the vat. The photopolymer cross-links and hardens upon exposure to photopolymerization wavelengths of light, changing the liquid resin into a solid polymeric material. These photoreactive 3D printing systems typically include a resin pool, an illumination system, and a print platform, where the illumination system projects an image into the resin pool causing a layer of a polymeric object to be formed on the print platform. The print platform then moves the printed layer out of the focal plane of the illumination system, and then the next layer is exposed (i.e., printed). Some systems use a “top-down” approach where the light exposes an upper surface of the resin, and then the print platform moves down into the vat so that the next layer can be built. Other systems are “bottom-up” where the light is projected through a transparent bottom surface of the resin pool, and then the print platform moves up, away from the bottom surface, as the part continues to be formed.

3D printing enables customized fabrication of parts, both structurally and in their material composition. One area in which 3D printing is utilized is for foams, such as in footwear, packaging, thermal insulation and other applications. Foams can be printed in open or closed cell foam configurations, in lattice-type structures or bubble configurations, and with tunable properties both locally and globally. In one example application, polyurethane foams are a common material used for creation of midsoles and other elements in footwear. For footwear, 3D printing enables customization advantages such as printing a lattice structure that varies in different regions of the midsole to impart specific cushioning and support properties in those regions.

Another developing area for the use of additive manufacturing is for parts that can transform. In this field, which is sometimes referred to as 4D printing, parts are additively manufactured with a structure that changes over time when exposed to an activation stimulus. The stimulus may be, for example, heat, cooling, light, or electricity. In one example, laminate structures have been produced in which fibers are placed into composite layers of a flat part, and an activation unit causes the composite structure to become curved. In another example, a lattice structure has active members that can self-transform when exposed to a stimulus, causing the part to change shape. Biomaterials is another area in which 4D printing is being applied, often using shape memory alloys and polymers or other “smart” materials (e.g., composites, hydrogels) in which the materials self-transform in response to a stimulus.

### SUMMARY

In embodiments, a method of creating additive manufactured parts from expanding foam material includes printing a part made of an expandable foam, using an additive manufacturing system. The expandable foam is printed in an unexpanded state and has a closed layer at an external surface of the part. The method includes controlling expansion of the part, using the additive manufacturing system, wherein the controlling of the expansion is performed after the printing.

In embodiments, a method of creating additive manufactured parts from expanding foam material includes modeling an expansion of a part made of an expandable foam. The method also includes printing the part made of the expandable foam, using an automated additive manufacturing system and according to the modeling. The expandable foam is printed in an unexpanded state and has a closed layer at an external surface of the part.

### BRIEF DESCRIPTION OF THE DRAWINGS

FIG. 1 shows various views of an additively manufactured expandable foam part, in accordance with some embodiments.

FIG. 2 shows various views of another additively manufactured expandable foam part, in accordance with some embodiments.

FIG. 3 shows cross-sectional views of an additively manufactured expandable foam part having a foam layer around a core material, in accordance with some embodiments.

FIG. 4 shows time-lapse photos of an additively manufactured foam part being expanded, in accordance with some embodiments.

FIGS. 5A-5B are side and bottom views of a part with selective regions of expansion, in accordance with some embodiments.

FIGS. 6A-6B are flowcharts for methods of creating additive manufactured parts from expanding foam material, in accordance with some embodiments.

FIG. 7A is a schematic of an additive manufacturing production line that may be used with embodiments of the present disclosure.

FIGS. 7B-7C are schematics of spinning apparatuses that may be used with embodiments of the present disclosure.

FIG. 8 is a diagram of a management platform that may be used with embodiments of the present disclosure.

FIGS. 9A-9D are illustrations of a photoreactive 3D printing system that may be used with embodiments of the present disclosure.

FIG. 10 shows an isometric view of a vat-based additive manufacturing system that may be used with embodiments of the present disclosure.

FIGS. 11A and 11B illustrate producing expandable foam parts in molds, in accordance with some embodiments.

### DETAILED DESCRIPTION

The present disclosure describes methods and systems for producing foam parts that are additively manufactured in a non-expanded state and later changed to an expanded state in a controlled manner. The expandability of the material is created by incorporating a foaming agent into a photopolymer, where the foaming agent is capable of producing voids/pores in the material when activated by a stimulus. The photopolymer is printed and cured, and then the foaming agent is activated after printing to expand gases within the printed material, thereby creating a foam structure. In some embodiments, the foaming agent contains gas in a gas form, where the gas is then expanded when activated by an activation stimulus. In some embodiments, the foaming agent has the capability of producing a gas, where the gas is created and expanded due to an activation stimulus. The expansion of the part may be controlled by an automated additive manufacturing system or may be designed to occur in a controlled manner after the part has been installed for use in the field. The parts have a closed exterior surface, such as having closed foam cells at its outer layer. The closed external surface beneficially avoids contamination of the microstructures inside the part. Printing the parts in an unexpanded state advantageously enables more parts to be produced on a build tray, thereby improving production rates. In some embodiments, the automated additive manufacturing system can control expansion of the part after printing, where the controlling can involve using sensors on the additive manufacturing machine or post-processing machines to provide feedback during the expansion.

Existing approaches for 3D printing of foams use microstructures (interconnected networks of cells), lattices, or other types of cell structures inside the foam material to achieve foam-like behavior, usually made from elastomeric materials which can be slow to print. Approaches purposely form the bubbles, voids, or open spaces from the structural geometry (e.g., lattices, cell walls), where the focus is on the geometry to create the sparseness. Known cell-type structures for foams can be open or closed cell, where in open cell structures or lattices the cells remain open at the surface of the geometry extents. Open cell structures present a disadvantage of having accessible voids that can trap debris or other particulates, impacting the performance of the material. For example, a microstructure-based or open cell-based footwear material may trap dirt, mud, or other particles. In a further example, conventional sintering methods often deposit and fuse thermoplastic polyurethane powder and require the use of open cell approaches to remove unused powder after printing. Similarly, in conventional resin-based 3D printing, the open-cell approach is used in order to allow trapped resin to drain. Conventional lattices and other microstructures can fail over time due to, for example, debris captured in voids or fatigue/stresses in the mechanical structure itself. Consequently, traditional 3D printed materials can be limited in their reliability and durability.

The present disclosure addresses these problems with a 4D approach—printing in three dimensions with the additional dimension of time. Methods and systems involve printing foam parts in an unexpanded configuration to be expanded later, such as in the context of an automated additive manufacturing system or flow. In some embodiments, the unexpanded state can be an approximately solid material (photopolymer with unactivated foaming agent(s)). In other embodiments, the as-printed material can have some voids/pores that are created during printing, but with much of the foaming agents still unactivated such that the part has the capability to be expanded further later. The foam structures have a closed layer (i.e., a closed outer shell) in the unexpanded state, in which the layer stays closed after the expanding. The closed outer shell of the expanded part may be a closed-cell foam, where the interior of the part may or may not have closed cells as well. The foam material(s) (of the interior of the part and closed outer shell/layer) expand after printing, changing toward its intended final part dimensions, all while having sealed outer surfaces. The sealed outer surfaces may be permeable to gases that enter the structure as the foam expands. The foam expands due to expansion of gases creating gas pockets in the material, causing the structures of the foam (e.g., cell walls, lattice elements, other microstructures) to move apart from each other. The printed material elements of the foam both lengthen and move away from each other as gas is expanded within the material so that the void spaces of the cell volumes increase.

Embodiments allow the creation of sparsity in the printed part without the need to remove excess print material (e.g., resin or powder). That is, a part is printed as an approximately solid or mostly solid piece that becomes less dense and remains sealed at the outer geometry extents after expansion. Printing foam-like pieces in an unexpanded state enables a new benefit of printing more pieces in a shorter time since the unexpanded pieces are smaller than expanded pieces. Another benefit of printing parts in an unexpanded configuration is that it is possible to fit more parts on a build tray, resulting in less resin material waste since more parts are built in a vat of resin at the same time. Further benefits include that the parts can remain unexpanded until closer to their end-use stage or even after being installed in an end product. Keeping parts in an unexpanded state can provide cost savings across the supply chain such as in storage space (e.g., in a warehouse), inventory costs (e.g., less space required to store products), and shipping costs (e.g., smaller shipping containers can be utilized, or more dense utilization of standard shipping containers can be made possible). Embodiments use a combination of geometry and chemistry to attain cell-type materials similar to conventional foams.

Embodiments use an expandable foam material which is made of a photoreactive resin into which one or more foaming agents are embedded. The foaming agents are particles (e.g., microspheres) which contain gas within them or contain materials capable of producing a gas when activated. The foaming agent does not necessarily react with the resin but is mixed into the resin to be able to create a foaming effect at a later time. The resin (with foaming agent) is printed and then illuminated at a polymerization wavelength to polymerize the resin. When an expansion stimulus is applied after the part is printed, the gases in the foaming agent increase in volume, causing the part to expand. The cross-linked polymer stays intact during expansion, thus preserving the cells (e.g., closed cells of the closed external layer) of the foam-like structure. That is, cross-linked polymer that surrounds particles of foaming agent embedded within the polymer becomes the walls of the foam structure, elongating and enclosing open spaces created by the foaming agent as the foaming agent reacts in response to the activation stimulus.

For example, an activation stimulus can heat up the printed part, causing gases in the foaming agent (e.g., microspheres) to expand and therefore expanding the diameter of the microspheres within the printed material. In other words, in some embodiments a foaming capability of the printed material is activated when heated to a critical temperature to expand gas that is contained within the foaming agent. The heat may be applied by, for example, an oven, microwave source, or other energy source. In some embodiments, heat is generated from an exothermic reaction that is activated by exposing (e.g., submerging) the printed part in a different gas or liquid.

Photoreactive resins (i.e., photopolymers, photosensitive resins) that can be used include acrylates, epoxies, methacrylates, urethanes (e.g., aliphatic, hydrophobic, dendritic), silicones, vinyls, and combinations thereof. An example of a foaming agent that can be mixed into the photoreactive resins, in accordance with embodiments, includes polymer shells that encapsulate a gas, such as EXPANCEL® microspheres. The encapsulated gas is a gas pocket that expands when heated, thus creating a foamed material. The microspheres may be activated at temperatures of, for example, 80° C. to 170° C. and may have a final expanded diameter of, for example, 40 to 120 microns. Another example of foaming agents is metal foaming materials such as zirconium hydride (ZrH), where ZrH when heated produces Zr and hydrogen gas. The hydrogen gas is created and expands as a result of heat being applied to the part, creating gas pockets (cells in the foam) enclosed by the final shape of the zirconium. Another example of a foaming agent that can be used in accordance with some embodiments is isocyanate mixed in with a resin (e.g., polyurethane). When exposed to water as an activation stimulus, the isocyanate reacts with the water to produce carbon dioxide gas. This isocyanate example may be implemented by, for example, adjusting a humidity level of the ambient environment in which the part is being printed. The humidity level can be adjusted for different layers of the part, thereby selectively causing expansion of those layers when exposed to a humidity level high enough to activate a reaction with the isocyanate in the part.

In some embodiments, the foaming agents are in the form of microspheres that are chosen to have a size and/or concentration in the resin that does not impact the viscosity for printability of the composite resin (i.e., composite resin is the resin with foaming agent, which is also referred to as an expanding foam or expandable foam in this disclosure). Microspheres may be used in concentrations in the resin in a range of, for example, 1% to 20%. In contrast, conventional 3D-printed foam parts are printed with foamed materials in an already-foamed state (foam cells at their final dimensions). For example, conventional foam materials are typically made by adding a blowing agent to a plastic material (e.g., blowing CO₂ into thermoplastic polyurethane to create the cellular structures) before being used in the additive manufacturing process.

Embodiments involve 3D-printing a foam-type material that later expands to a final part geometry that can be used in a variety of industries, with footwear being a prime example. Embodiments allow the ability to print more parts on a tray when in a non-expanded form, thereby using less volume of material and increasing 3D print speed and ultimately manufacturing throughput. Embodiments also enable parts to remain unexpanded until a later time or location such as when being assembled into a final assembly or being prepared for sale to a consumer. The foam can have internal sparsity but is sealed on the shell (outer boundary) of the geometry that it forms due to the cured photoreactive polymer staying intact during expansion.

Embodiments may also advantageously use automation, robotics, computer vision, artificial intelligence, and other industrial manufacturing subsystems to mass produce parts that make use of these expanding foam materials, with the added advantage that the parts can be customized or identical to each other. Such automated flows improve the quality of each part while maintaining traceability throughout each step in the process (e.g., 3D printing stage, drying stage, spinning/post processing stage, inspection station, etc.).

Methods and systems of the present disclosure enable a price point that is comparable to or better than production costs of conventional foam products. Embodiments achieve the same physical properties as existing foam materials, but with improved manufacturing aspects of an automated 3D printing manufacturing flow such as customization, speed, high quality, and manufacturing with less labor. Embodiments also provide large upfront capital savings due to the lack of needing to invest in a tool or mold for producing the part as in conventional approaches. Application examples include footwear, toys, grips, handle grips, composite cores (e.g., a foam core that is machined then wrapped in carbon fiber), helmets, medical applications, thermal insulation, sound absorption, sound acoustics control, microphone components, mechanical absorption (e.g., cushioning) and automotive or space (e.g., dashboards, seat cushions, and other energy absorbent parts). In short, the present embodiments provide expanding foam materials that can offer improved quality compared to conventional foams, and which can be produced within an automated additive manufacturing flow thus enabling the high-volume production of parts for numerous industries.

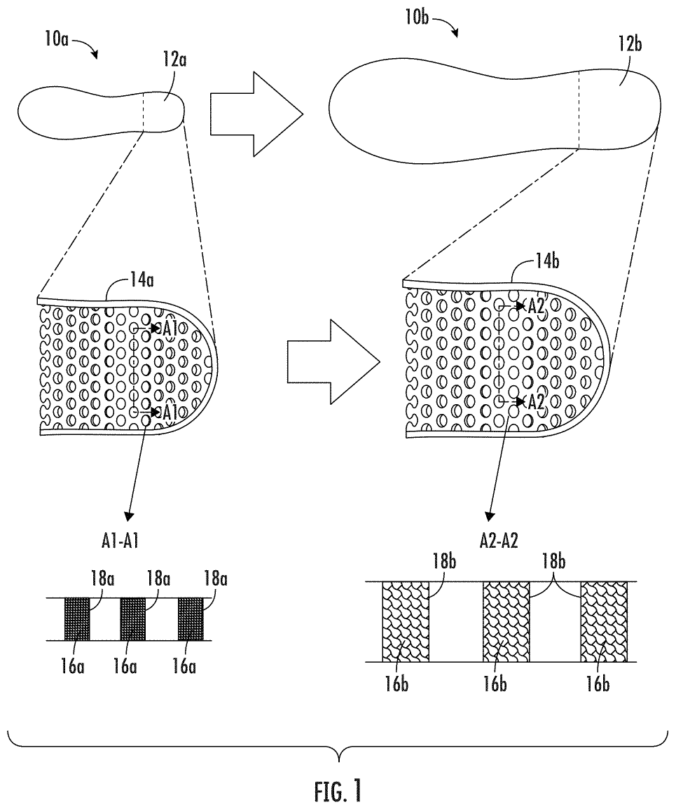

FIG. 1 shows an embodiment of an additively manufactured midsole for a shoe, in accordance with some embodiments. The midsole is printed in an unexpanded state shown by part 10a which can later be changed to an expanded state shown by part 10b, such as in a controlled expansion process during the manufacturing flow or at a later stage of the product (e.g., after being shipped to another location and/or after being stored in a warehouse). In FIG. 1, close-up views 14a and 14b of the heel section for the unexpanded heel 12a and expanded heel 12b, respectively, are shown. The heels 12a and 12b are configured as a slab having an array of open circular through-holes, where the material surrounding the holes is a printed foam material. Cross-section A1-A1 of view 14a shows that the unexpanded foam 16a of the unexpanded part as-printed is dense. Cross-section A2-A2 of view 14b shows that the foam 16b of the expanded part is less dense than the unexpanded part, having larger open spaces due to expansion of gas within the printed part, which causes the structural elements of the foam material (e.g., cell walls, lattice elements) to move apart from each other during expansion. The exterior surfaces 18a and 18b of the unexpanded and expanded parts, respectively, form a shell around the part 10a,b and are all the surfaces of the part that are exposed to (e.g., adjacent to) the ambient environment. In some embodiments, the part is made of the same material throughout, with the exterior surfaces 18a,b being a closed-cell foam that is the same material as the foam 16a,b in the interior of the part. In other embodiments, the exterior surfaces 18a,b may be a closed-cell foam that is a different material as the foam 16a,b (closed or open cell) in the interior of the part. The exterior surfaces 18a,b enclose the interior of the part in the expanded state, thus preventing debris or other contamination from entering the foam structure 16a,b and consequently increasing durability and reliability of the part.

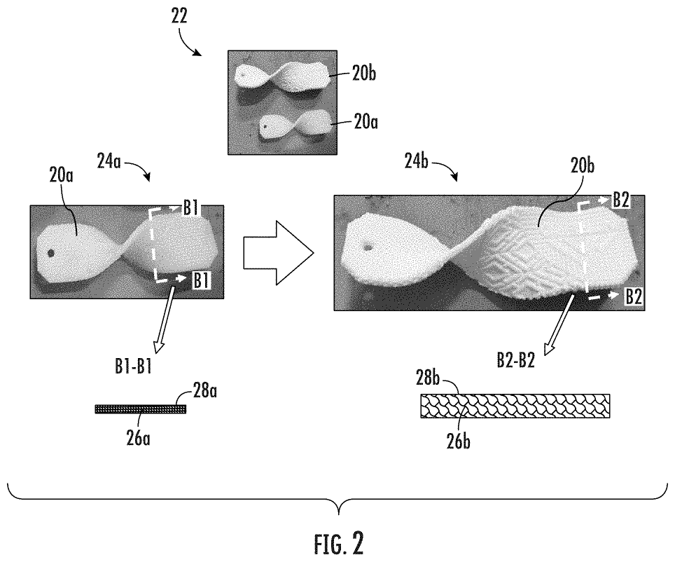

FIG. 2 shows another example of a printed part, providing a general demonstration of expansion of a printed expandable foam in accordance with some embodiments. The part in this embodiment is a strip that is printed in a 180-degree twisted shape, with the strip having geometric raised patterns along its surface. The part is printed as an unexpanded piece 20a which is then is later increased in size to become expanded piece 20b. A comparison view is shown in image 22, while close-up views of unexpanded piece 20a and expanded piece 20b are shown in images 24a and 24b, respectively. It can be seen from image 22 that printing small scale versions of parts that will eventually expand allows the ability to pack more parts on a build tray than full-size parts. Cross-section B1-B1 of the unexpanded part 20a shows an unexpanded foam structure 26a that has smaller or no open spaces compared the foam structure 26b of the expanded part 20b in cross-section B2-B2. The outer surface 28a of section B1-B1 is a sealed layer created by the closed-cell structure of unexpanded foam 26a. The outer surface 28a stretches out to become outer surface 28b in the expanded state, but still provides a closed wall for the interior material (foam 26b) within the part as described in relation to FIG. 1.

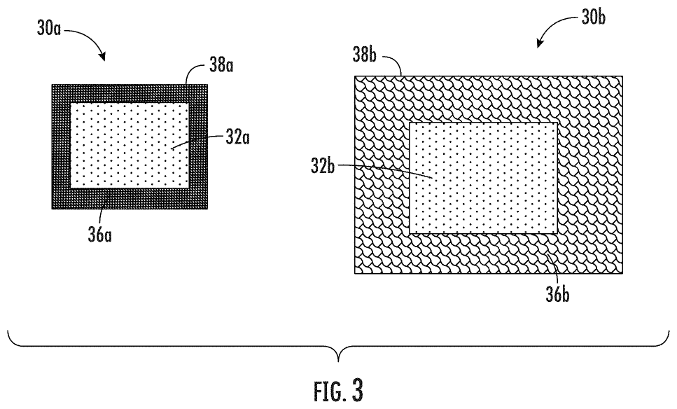

The exterior surfaces may be configured in different ways to create a sealed outer shell around the part. In some embodiments, the exterior surfaces may be the same material as the interior foam as described in FIGS. 1 and 2, all being made from a closed-cell foam material. In some embodiments, the closed exterior surfaces may be created by an expandable foam layer around a core material that is different from the foam of the closed exterior surfaces. For example, in FIG. 3, cross-sectional views of an unexpanded part 30a and expanded part 30b are shown. A core material 32a,b is surrounded by an expandable foam 36a,b (unexpanded and expanded states, respectively). The core material 32a,b may be an expandable open or closed-cell foam, or may be a non-foam material. The expandable foam 36a,b is a closed cell foam that maintains a closed layer 38a,b around the exterior of the part during expansion. In embodiments where both core material 32a,b and foam 36a,b are expandable foam, the materials may expand at the same rate or different rates than each other. For instance, foam 36a,b may expand at a faster rate than core material 32a,b when exposed to the same stimulus (e.g., heating at the same temperature). In embodiments that may apply to any examples in this disclosure, the outer layer of expandable foam 36a,b may be formed during the additive manufacturing of the part or after the additive manufacturing. An example of applying the outer layer of expandable foam material after the additive manufacturing includes dipping, spraying, or otherwise coating an additively manufactured core part with the expandable foam, and optionally spinning the part to distribute the expandable foam material.

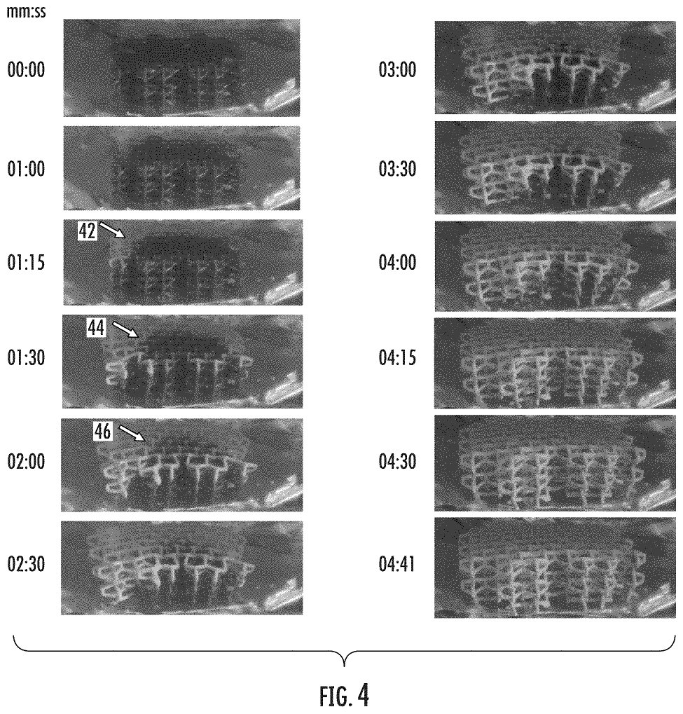

FIG. 4 is a time lapse sequence of an expandable foam part printed as a lattice geometry. In this embodiment, macro-properties of the part can be customized by aspects of the lattice geometry (e.g., unit cell size, strut thickness) while micro-properties can be customized by the material properties of the expandable foam that the part is printed with. The prototype of FIG. 4 was made of a resin formulation of acrylate, urethane, photoinitiator, and microspheres. After printing the lattice structure, the part was exposed to heat at approximately 100° C. in a convection oven. At time 00:00 minutes:seconds, the part has been printed but has not been exposed to a stimulus to activate expansion. In the subsequent photos, a stimulus is applied (e.g., heat, light or other) and the printed lattice structures begin to expand, thereby moving the lattice structures away from each other such that the unit cells of the lattice enlarge. The expansion in this prototype begins at the edge regions of the part, as indicated by the arrow at time 1:15 for region 42. The expansion progresses inward, as indicated by example arrows for regions 44 and 46 at times 1:30 and 2:00, respectively, until the entire extent of the part has been expanded. The initial length and width dimensions of the part were approximately 70 mm×50 mm which were expanded to approximately 100 mm×87 mm. The final foam cell sizes, after expansion, ranged from approximately 40 μm to 120 μm diameter.

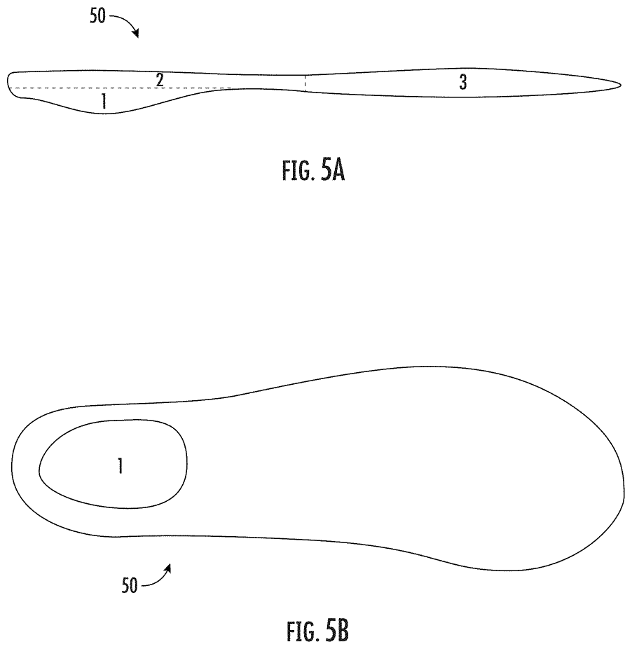

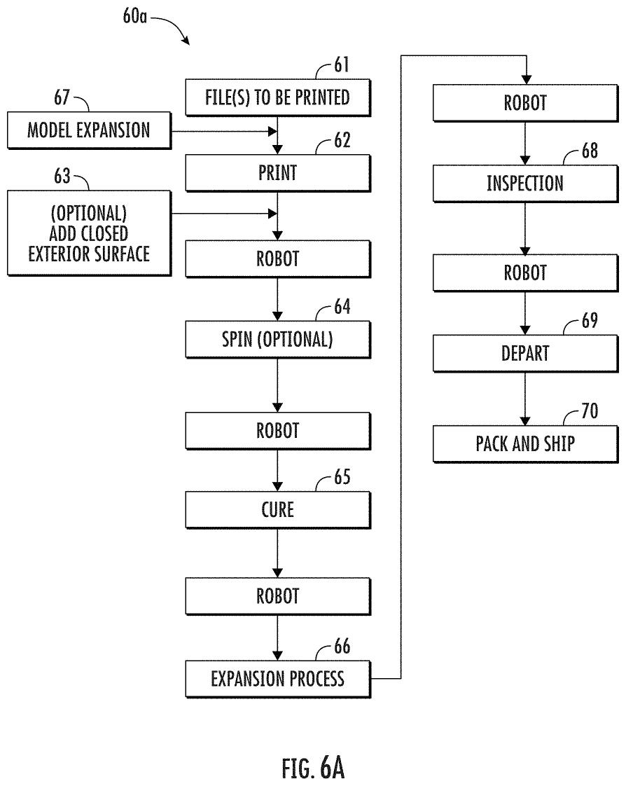

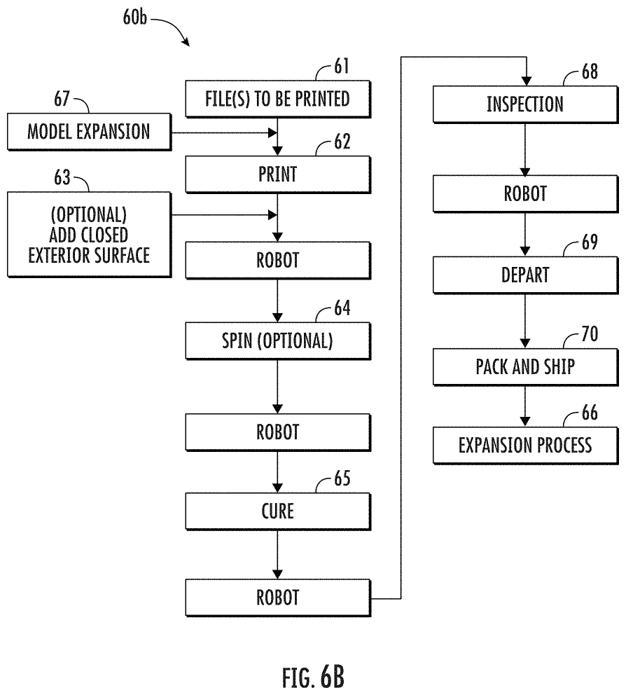

FIGS. 5A-5B demonstrate the ability to selectively expand foam in different regions of a part, in accordance with some embodiments. This embodiment uses a mid-sole 50 for a shoe as an example, where FIG. 5A is a side view and FIG. 5B is a bottom view. In this example, region 1 in the heel area may be designed to undergo the most expansion, such as to provide a high amount of cushioning for the user's heel. Region 2 along the rear half of the foot can be designed to undergo the least expansion. Region 3 along the front section of the foot can be designed to have an expansion level that is in between regions 1 and 2. In some embodiments, the selective expansion (i.e., difference in expansion rates among the three regions) is achieved by printing a customizing material that customizes a property in the part, where the customizing material can be applied in a designated region of a layer of the part. The customizing material may be, for example, an activator or inhibitor for the controlling of the expansion. The customizing may be achieved by printing different materials with different mechanical properties (e.g., durometer, foam densities) in the various regions. In some embodiments, the selective expansion can be achieved by controlling the stimulus that activates expansion of the foam material, where the stimulus may be, for example, applied or not applied in certain regions of the part, or can vary in magnitude from region to region of the part. In some embodiments, both the materials and expansion activation can selectively be varied in the different regions. As an example, regions 1, 2 and 3 can have different porosities and/or mechanical properties from each other, where the different mechanical properties are created by starting with the same or different materials, with the same or different foaming agents, and then the same or different stimulus/stimuli can be used to cause the regions to expand at different rates or amounts from each other. Printing methods to achieve these regions of selective expansion shall be described in more detail in relation to the flowcharts of FIGS. 6A-6B.

FIG. 6A is a flowchart that illustrates various steps to produce parts made of expanding foam materials using additive manufacturing. Flowchart 60a represents methods for printing expanding foam materials in an additive manufacturing factory flow, which can be an automated system in some embodiments. As an example, a workstation of the additive manufacturing system can be used to automate the expansion of the part in a post-processing step of the manufacturing workflow. The automated system can also be used in mass producing the foam parts. Embodiments may include a closed loop feedback system for 3D printing accuracy and speed, and may also include spinning the printed parts for efficient post-processing. Closed loop systems can include those described in U.S. Pat. No. 10,647,055, issued on May 12, 2020, and entitled “Closed Loop Print Process Adjustment Based on Real Time Feedback,” which is owned by the present assignee and is hereby incorporated by reference. Embodiments may also include a cloud management platform to guarantee part quality and traceability throughout the entire production process. The cloud management platform can include those described in U.S. Pat. No. 11,054,808, issued on Jul. 6, 2021, and entitled “Management Platform for Additive Manufacturing Production Line,” which is owned by the present assignee and is hereby incorporated by reference. The cloud platform can help identify aging equipment, predict hardware failure, and schedule print jobs and post processing steps.

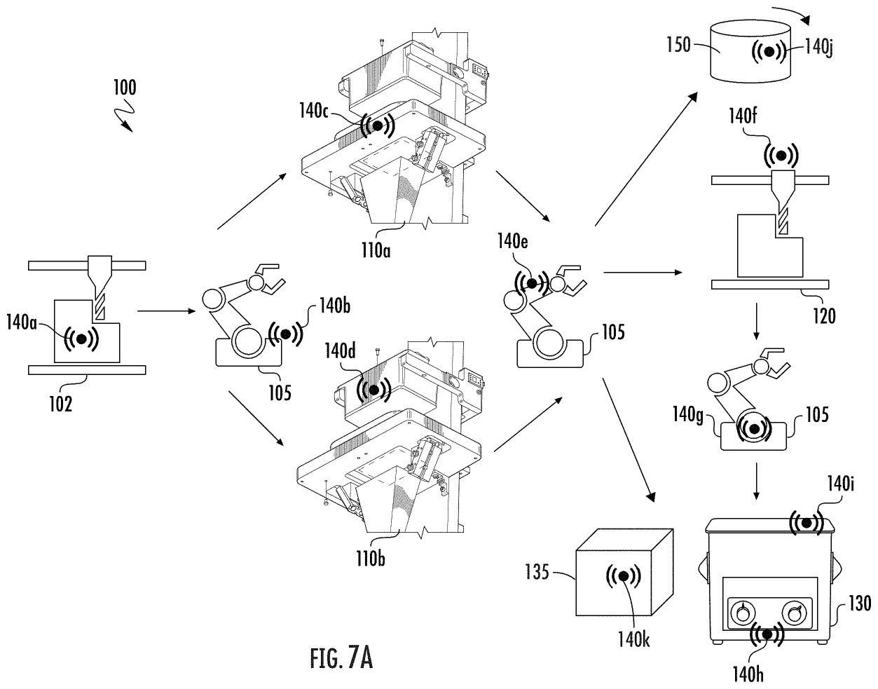

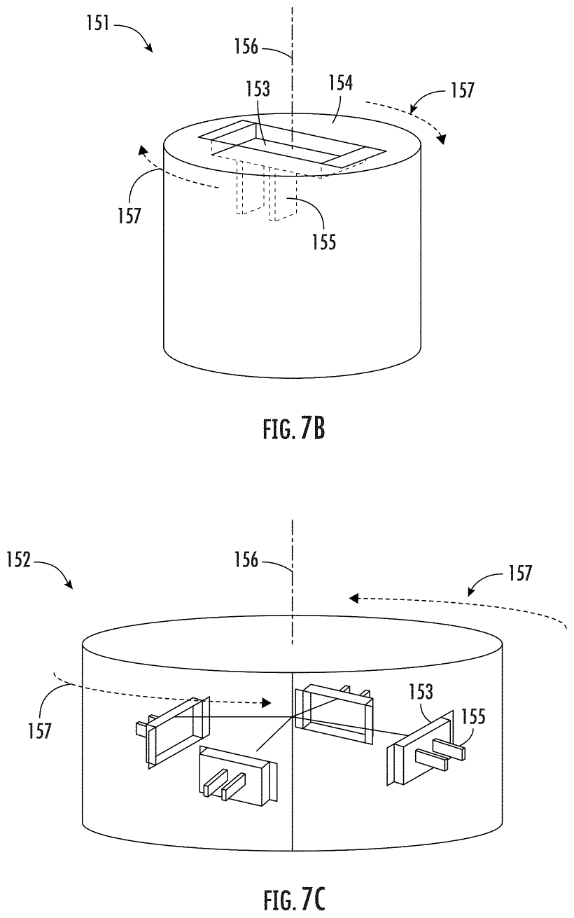

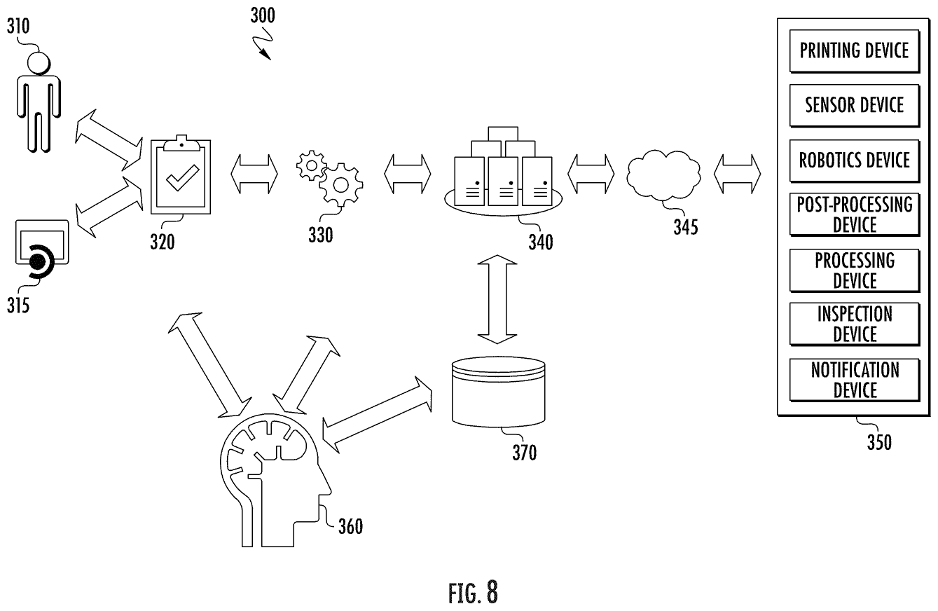

The flowchart 60a begins with block 61 where the system receives file(s) for the part to be printed. The files can include information about the part geometry, material, and tolerances, which can then be translated into print instructions (a print recipe) for the additive manufacturing machine. For example, the print recipe can include parameters and instructions related to build geometry, illumination energy, exposure time per layer, wait time between layers, print platform position, print platform velocity, print platform acceleration, resin tub position, resin tub force, resin chemical reactivity, and resin viscosity. In some embodiments, the additive manufacturing system can be a closed loop system (e.g., see FIGS. 7A and 8) that has sensors on the additive manufacturing machine as well as on other auxiliary equipment, where the sensors provide feedback for updating the print recipe before, during, and/or after a print run. Such a closed loop system can be employed to optimize quality, speed, and accuracy, for instance by providing closed loop feedback on resin temperature, forces on the build tray, measurements of tray position, and/or other parameters to adjust the print recipe in real time. For the expanding foam materials of the present disclosure, the additive manufacturing system can translate the final dimensions supplied by the print files into dimensions of the non-expanded part that is to be printed, or in other embodiments the user can provide the desired pre- and post-expanded dimensions. In some embodiments, this translation of dimensions can be performed in block 67 of modeling the expansion, which shall be described below.

In block 62, the part is printed. The additive manufacturing machine for printing a part in block 62 can be various types as shall be described later in this disclosure. For example, the additive manufacturing printer can be a top-down or bottom-up image projection type of system in which an image of the layer to be printed is projected onto a bottom surface of a resin tub or onto a top surface of photosensitive resin in a resin vat, and then the layer is polymerized by illuminating the resin layer. In another example, the additive manufacturing machine can be a vat-based system in which one or more materials (e.g., resin component, polymerization reactant, expansion activator, expansion inhibitor, or component to customize material properties) are dispensed (e.g., jetted) onto a liquid contained in the vat. The vat-based system may be as described in U.S. Pat. No. 11,110,650, issued on Sep. 7, 2021, and entitled “Vat-Based Additive Manufacturing with Dispensed Material,” and which is owned by the present assignee and is hereby incorporated by reference. In embodiments of using a vat-based system, layers for an expandable foam part can be printed by dispensing materials to precisely deposit ingredients/reactants of the foam material (e.g., foaming agents and/or reactants of the resin).

The printing in block 62 can involve varying the properties in different regions of the part as illustrated in FIGS. 5A-5B. For example, a vat-based dispensing system can be used to adjust ingredient concentrations and/or types of foam materials (e.g., foaming agents, etc.) across a layer or from layer to layer in order to customize mechanical properties in desired areas of the part. The dispensed materials can also include substances to control expansion parameters, where the amount or type of the dispensed substance (e.g., activators, accelerants or inhibitors for reactions to heat, light, etc.) causes increased or decreased expansion in the region in which the substance is present, compared to other regions. For example, the printing may be achieved by providing a first composition in a vat and dispensing a second composition onto the first composition, where polymerization components for formation of a layer of a part to be created may be separated from each other, with at least one of the polymerization components in the first or the second composition. The second composition (e.g., containing an activator or inhibitor for controlling expansion, or containing a different material from the first composition) may be selectively dispensed in desired regions where certain material properties are desired.

In blocks labeled “Robot” in FIG. 6A, automated equipment such as industrial robots and/or conveyor systems (e.g., belt conveyors, roller conveyors) can be used for moving parts from one station of the production line to another. The robots can be equipped with sensors to provide feedback for the manufacturing flow, such as vision or weight sensors to detect when parts have been damaged, or that a part has not expanded properly. The automated equipment and sensors may be those as described in U.S. Pat. Nos. 10,647,055 and 11,054,808, incorporated above. In some embodiments, the robots may be omitted from one or more locations of the manufacturing flow 60a (e.g., parts may be moved manually between stations instead of in an automated fashion).

In embodiments, the part is printed with a closed outer shell (i.e., closed layer of the external surfaces) during the 3D printing itself. Instructions for creating the exterior shell can be incorporated into the print recipe for the 3D printer, such as printing a closed-cell expandable foam on the perimeter of the part. The closed outer layer can be the same material as throughout the part (e.g., FIGS. 1, 2) or can be a closed-cell foam that encloses a different core material (e.g., FIG. 3). In some embodiments, the exterior shell can be created during a block 63 in FIG. 6A that is separate from the printing. For example, a part made of expandable or non-expandable foam can be printed by additive manufacturing (e.g., core material 32a,b of FIG. 3), and then the part can be dipped into an expandable foam resin (resin with foaming agent) to coat the overall part. The coating thereby creates the closed outer geometry of the part, maintaining its closed structure after expansion.

In some embodiments, flow 60a optionally involves spinning in block 64 to optimize post-processing efficiency by avoiding the need to wash part(s) after printing and allowing the ability to provide exterior coatings for property customizations. The spinning can be performed according to U.S. Pat. No. 10,759,116, issued on Sep. 1, 2020, and entitled “Additive Manufactured Parts with Smooth Surface Finishes,” which is owned by the present assignee and is hereby incorporated by reference. In some embodiments, the spinning involves removing and/or distributing resin that remains on the part after printing. The spinning reduces the need for a wash step to remove the excess resin and can also create a smooth surface finish for the part prior to curing. In some embodiments, a coating material can be added to the part after printing, such as by dipping. Spinning can be used to distribute the coating, create a smooth surface finish, and/or control the thickness of the coating. In some embodiments, the coating may be used to create the exterior shell of the expandable foam part.

After the part has been printed and any further layers added (e.g., coatings to create an outer shell or to a particular surface finish), the part is cured in block 65. In some embodiments, the coating or surface finish material (if included in the part) may harden on its own, such as through natural drying or through an inherent chemical reaction. In some embodiments, curing may be achieved using application of energy involving one or more of various known methods, such as high-intensity discharge bulbs in an inert gas (e.g., argon, nitrogen, or other gases to displace oxygen) and/or any light source with or without an inert gas. In embodiments where a specific curing step occurs, the curing process can make the part more rigid and stable and harden the uncured layer of resin that remains on the part. Elements of the cloud management platform referenced above can be employed, where temperature can be monitored to optimize curing parameters, for example. In one embodiment, the oxygen level in the cure chamber can be monitored by the additive manufacturing system to ensure that the oxygen is depleted after purging (e.g., after N₂ or argon or other gases heavier than oxygen are injected into the chamber to deplete oxygen). Oxygen inhibits curing, thus it is desirable to deplete oxygen from the chamber before the curing process begins.

Next in block 66 of FIG. 6A, the part which was printed in a non-expanded state is expanded. In some embodiments, the expansion process in block 66 may advantageously automate and control the expansion of materials. For example, block 66 may involve controlling expansion of the part, using the additive manufacturing system, wherein the expansion is performed after the printing. An expansion stimulus is employed to expand the foam material, where the stimulus can be at least one of: vacuum (e.g., to assist in moving cell walls apart as gases within the part expand), an additive, an activator, or application of energy from an energy source. In one embodiment, an activator may cause the part to expand over time after being printed. In some cases, the timing of the controlled expansion (i.e., controlling when the expansion occurs) can be adjusted by the automated additive manufacturing system, such as by controlling when an expansion stimulus will be applied. Examples of energy that can be used include heat, electrical, magnetic, electrostatic, ultrasonic, or infrared (IR) or ultraviolet (UV) light. Equipment that can be used to apply the expansion stimulus/activation include, for instance, convection ovens, radiant heat, IR heat with blowers, vacuum oven chambers, microwaves with or without localized heating, directed lasers, pneumatics and other pressure sources, or chambers equipped with some or all of these. Some embodiments may include sensors and camera systems to monitor expansion rates, with computer vision and artificial intelligence (AI) running in the background to optimize expansion control. Some embodiments involve adding an additive/activator to the part to kick-off the reaction after the part has been printed, such as by applying a coating to the part or dipping the part in an activator (e.g., via a liquid or vapor bath). Controlling the expansion by the additive manufacturing system may be performed through wireless or wired communication between a central processor and the expansion equipment. The expansion equipment may be located in the same manufacturing facility as the additive manufacturing machine (used in block 62) or may be in a different location such as in cases where the part is expanded at a later stage of the product cycle (e.g., expansion may be controlled remotely through electronic/cloud communication).

In one example of expanding the part in block 66 using a heat trigger, a foaming agent in the part can be activated at a certain temperature. A temperature sensor and camera (or other imaging device) can be used to measure temperature and expansion as a function of time to determine a rate of expansion. The rate of expansion can then be controlled in a number of ways such as by adjusting the heat intensity, time of heat exposure, and/or applying physical constraints to control the shape of the expanded object (e.g., expanding the part within a mold). In an example of heat adjustment, a radiant heat source can be set up to create a convection-type heat source that can be used to adjust the amount and locations of heat applied to the part. In some embodiments, the part is placed in a vacuum oven while the part is being expanded, where the vacuum pressure (i.e., low or reduced pressure, such as from 0 psi to −14.5 pounds per square inch (psi), or −5 psi to −10 psi, or approximately −7.25 psi; i.e., 0 kPa to −100 kPa, or −34.5 kPa to −70 kPa, or approximately −50 kPa) encourages the lattice/cell structures of the part to move away from each other to aid in expansion of the overall part. The various activation stimuli that trigger activation can be monitored and adjusted in real-time via the use of sensors, cameras, imaging devices, computer vision algorithms, or combinations thereof. In embodiments, the controlling of the expansion of the part involves using a stimulus to activate the expansion after the printing, and involves monitoring and adjusting the stimulus to control a rate of the expansion.

Embodiments include other ways of selectively controlling the expansion that are aided by predecessor steps in the manufacturing flow. For example, when using vat-based/dispensing systems for the printing in block 62, the concentration of the expansion ingredients (e.g., foaming agent) can be selectively dispensed in certain areas of the part to accelerate expansion during the expansion process. In other embodiments, expansion inhibitors can be dispensed in areas where little expansion is desired. Examples of expansion inhibitors include heat resistant coatings for plastics such as carbon composites, polytetrafluoroethylene (PTFE), and perfluoroalkoxy (PFA). The objective of selectively controlling the expansion can similarly be achieved during the spinning in block 64 where a coating of either expansion accelerant, expansion activator or expansion inhibitor can be applied to the part. In short, the expansion process can be automated and controlled by an additive manufacturing system in a number of ways by reading and reacting to sensor data (e.g., feedback from temperature sensors, imaging devices), selective application of ingredients in predecessor steps (e.g., printing, post-process spinning), applying physical constraints (mold or physical blocking material), and/or combinations thereof. All of this can be automated in an additive manufacturing flow to achieve high volume mass production of parts, whether custom or not.

Embodiments of FIG. 6A can also include block 67 of predicting and modeling the expansion of the part made of expandable foam. In some embodiments, finite element analysis (FEA) may be used for emulating the expansion of the base material, to create a simulated expansion that can be used to modify the input geometry (geometry to be printed by the 3D printer) to remove undesirable warping or changes in shape compared to desired final (expanded) dimensions. The predicting and modeling may utilize artificial intelligence, such as training a neural network to modify the geometry before or during a print run based on how the part will be expanded. The trained neural network can be, for example, a general adversarial network (GAN) or a convolutional neural network (CNN) trained on theoretical models, actual data from previous manufacturing builds, and/or real-time data to learn (e.g., in real-time or at a subsequent time after the data is input) what modifications are needed in the print recipe to achieve the desired expansion after printing. For example, algorithms (e.g., one or more algorithms used together) may be used to modify the geometry of the part to be printed based on potentially non-isometric expansion to achieve the final part dimensions. That is, embodiments can use algorithms to modify the geometry to produce net part dimensions (i.e., final part dimensions) after expansion if the expansion is not isometric (i.e., amount of expansion varying in different directions). In an example of predicting and modeling expansion, a rate of expansion can be determined by reading data from an imaging device (e.g., camera) and temperature monitoring device (e.g., thermal imager), where the gathered data is used to create a predictive model or a “look-up-table” entry. The model or table can then be used as part of an algorithm that makes adjustments in real time to either control the temperature of that region during printing (e.g., less exposure time or more time between exposures, or deeper layer pump, etc.) or during the expansion process (e.g., more heating or cooling applied to a specific area) to yield a unique characteristic of the final part geometry. The modifications can be input to the 3D printer to adjust the print recipe as needed. In some embodiments, sensors on the 3D printer and/or auxiliary equipment can provide feedback to make further adjustments to the expansion model, such as by measuring dimensions downstream and assessing whether the expanded part matches the predicted model. The modeling in block 67 is shown in FIG. 6A as occurring just prior to the printing in block 62, but can occur elsewhere in the flow such as prior to receiving or generating the print files in block 61, or in real time during the printing within block 62.

In inspection block 68, an automated optical inspection or a computer vision system can be used to reject or accept parts based on visual correlation between such parts and their nominals (i.e., specifications). Inspection can be used to provide feedback for the printing in block 62 and/or the modeling in block 67.

In block 69, the finished, expanded pieces are departed from the build tray. An automated departing system can physically remove the parts from a build tray and place them into an output system (e.g., conveyor, chute, staging area, etc.) to be presented for packaging and shipping in block 70.

An example use case for the expanding foam parts of the present disclosure is gaskets. A 3D-printed geometry for a gasket can be printed with an expandable foam in a non-expanded state, then inserted into a gap space in an assembly. The foam part is later expanded to fill the gap, thus serving as a gasket. The expansion can be triggered by a variety of means (e.g., time, heat, activator, blowing agent, or various energy sources besides heat such as electrical, IR, magnetic, UV, electrostatic, ultrasonic, etc.). This delayed expansion of a gasket can be useful, for example, when working on reconditioning older part assemblies where it is helpful to have the assembly components remaining mobile or loose until repaired. Other example use cases include engine reconditioning (e.g., gaskets in engine) and medical applications.

The delayed expansion can occur during the manufacturing process, such as in FIG. 6A, or during use of the part in the field as illustrated in flowchart 60b of FIG. 6B. FIG. 6B illustrates various steps to produce parts made of expanding foam materials using additive manufacturing. Some steps in the flowchart in FIG. 6B are the same as or similar to the steps in FIG. 6A, as described herein. In FIG. 6B, the file(s) to be printed are supplied in block 61, then the part is printed in block 62. In some embodiments, expansion of the part can be modeled in block 67, such as before the printing in block 62. In some embodiments, the closed layer of expandable foam can be added in a separate block 63 rather than being formed during the printing in block 62. The flowchart 60b proceeds with an optional spinning of the part in block 64 and with curing of the part in block 65, both as described above in relation to FIG. 6A. FIG. 6B differs from FIG. 6A in that the expansion process of block 66 occurs after the part has undergone inspection in block 68, departing in block 69, and packaging and shipping in block 70. The expansion process of block 66 in FIG. 6B may occur, for example, after being stored in a warehouse and in preparation for being sold to a consumer, or after arriving at a secondary manufacturer (e.g., in preparation for being assembled into another product), or when in use by a consumer.

Another use case for the expanding foam pieces of the present disclosure is for safety measures, where a part could be triggered to expand to block an unwanted flow (e.g., water, gas). Fire and excessive heat safety situations are another example application, where a 3D printed non-expanded part can be triggered to expand when exposed to a certain amount of heat, thereby creating an insulator. This can buy time for time critical operations during a fire or unsafe heat related incidents. For example, in aerospace applications, the material can be designed to become a foam (expand) when exposed to heat, thereby creating a thermal barrier due to the closed-foam cells of the expanded structure. Embodiments can also be applied to general creation of insulators in the automotive, aerospace, prosthetics, and other industries.

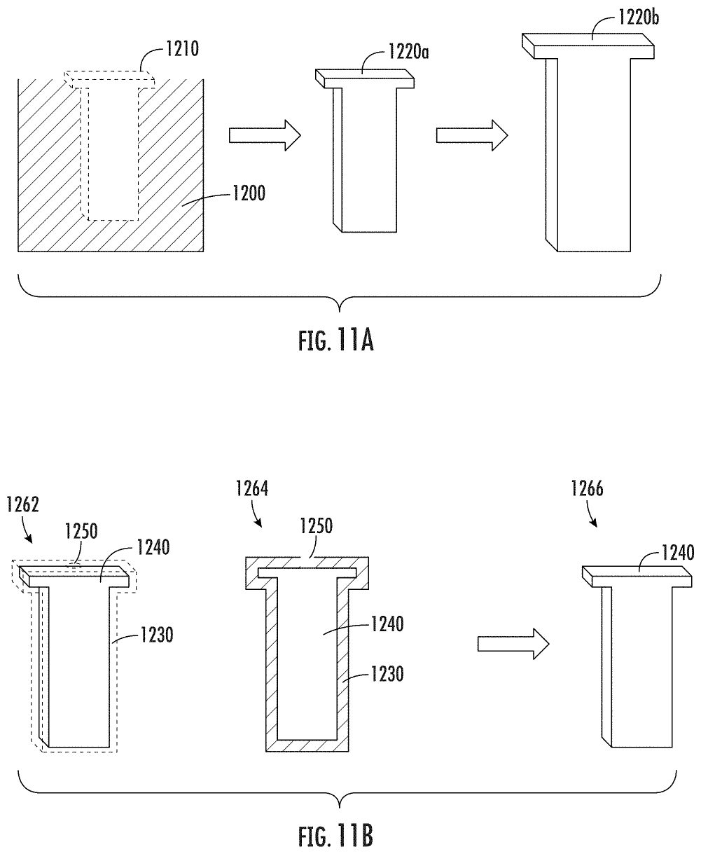

In other embodiments, the part can be printed in block 62 of FIGS. 6A or 6B with techniques other than 3D printing. For example, FIG. 11A illustrates a tool 1200 (e.g., a mold) having a cavity 1210 which can be filled with an expandable foam, such as a two-part urethane having a foaming agent. The density of the final foam part can be varied based on the amount of urethane injected. When the urethane touches the cavity wall, it seals and creates a formed foam part 1220a which is a closed cell structure (closed cells at least in a closed layer at an external surface of the part) in the shape of the cavity 1210. The mold-injected foam part 1220a can later be expanded to an expanded part 1220b as described herein. Another embodiment of this urethane approach is illustrated in FIG. 11B, in which a thin-walled consumable 3D-printed mold 1230 is filled with an expandable foam (e.g., a two-part urethane foam) through an injection port 1250. Schematic 1262 is an isometric view, schematic 1264 is a cross-sectional view, and schematic 1266 is an isometric view of the produced part after the mold is removed. The mold 1230 may be a digitally precise 3D-printed mold that serves as an “eggshell” where the eggshell can be easily removed/cracked as a post-processing step. For this eggshell approach the mold 1230 can be a lattice frame around the printed part 1240 to prevent failure (e.g., physical damage, cracking, bursting, etc.) during urethane injection. The produced part 1240 can be expanded later as described herein.

Methods for creating additive manufactured parts from expanding foam material in accordance with the present disclosure include printing a part made of an expandable foam, using an additive manufacturing system. The expandable foam is printed in an unexpanded state and has a closed layer at an external surface of the part. Methods also include controlling expansion of the part, using the additive manufacturing system, wherein the expansion is performed after the printing. In some examples, expansion of the part may be performed without the additive manufacturing system, such as by another piece of equipment at a later time and/or at another location than when the part was manufactured.

In some embodiments, the closed layer comprises a closed-cell foam after the expansion. In some embodiments, the external surface comprises all surfaces of the part that are exposed to an ambient environment. In some embodiments, the expandable foam comprises a foaming agent in a photoreactive resin. The foaming agent may comprise particles containing a gas, where the controlling involves expanding the gas during the expansion of the part.

In some embodiments, the method further comprises dipping the part in a coating material after the printing and before the controlling the expansion, where the dipping can be used to create the closed layer. In some embodiments, methods further include spinning the part on a spinning apparatus after the printing, to coat the part with an expansion accelerant, an expansion activator or an expansion inhibitor.

In some embodiments, the printing further comprises printing a customizing material that customizes a property in the part, where the customizing material is printed in a designated region of a layer of the part. The property may be a mechanical property. The customizing material may be an activator or inhibitor for the controlling of the expansion.

In some embodiments, the controlling uses a stimulus to activate the expansion of the part after the printing, and the controlling comprises monitoring and adjusting the stimulus to control a rate of the expansion of the part. The stimulus may be at least one of a vacuum (i.e., vacuum pressure), an additive, an activator, or energy from an energy source. The energy may be heat energy, electrical energy, magnetic energy, electrostatic energy, ultrasonic energy, infrared light, or ultraviolet light.

In some embodiments, the additive manufacturing system is an automated system comprising an additive manufacturing machine, a post-processing machine (e.g., an expansion equipment for performing the expansion of the part), and sensors on the additive manufacturing machine and the post-processing machine, where the sensors provide feedback during the controlling of the expansion. In some embodiments, the methods further include modeling the expansion before the printing, where the modeling is performed by the automated additive manufacturing system. The modeling may account for non-isometric expansion to achieve desired final part dimensions.

Methods include creating additive manufactured parts from expanding foam material, the method comprising modeling expansion of a part made of an expandable foam; and printing the part made of the expandable foam according to the modeling, using an automated additive manufacturing system, where the expandable foam is printed in an unexpanded state and has a closed layer at an external surface of the part. In some examples, the closed layer comprises a closed-cell foam that remains closed after the expansion. In some examples, the external surface comprises all surfaces of the part that are exposed to an ambient environment. In some examples, the expandable foam comprises a foaming agent in a photoreactive resin, where in some cases the foaming agent comprises particles containing a gas, and the modeling comprises modeling expansion of the gas during the expansion of the part. In some examples, the modeling comprises modeling a stimulus to activate the expansion after the part is installed for use. In some examples, the methods further include applying, by the automated additive manufacturing system, a stimulus to expand the part to an expanded state, where in certain cases the stimulus is at least one of a vacuum (i.e., vacuum pressure), an additive, an activator, or energy from an energy source, and the energy comprises heat energy, electrical energy, magnetic energy, electrostatic energy, ultrasonic energy, infrared light, or ultraviolet light.

FIG. 7A is a schematic of an additive manufacturing production line 100 (i.e., additive manufacturing system) as described in U.S. Pat. No. 11,054,808, which can be used in embodiments of the present disclosure. The production line 100 includes at least one additive manufacturing machine, where two 3D printers 110a and 110b are illustrated. The production line also includes auxiliary equipment 102, 105, 120, 130, 135, and 150. Auxiliary equipment 102 may be used prior to printing a part on printer 110a or 110b. For example, auxiliary equipment 102 may be a computer numerical controlled (CNC) mill that prepares a build tray or a scaffold for a 3D printed part. Auxiliary equipment 105 are machines such as industrial robots and/or conveyor systems for moving parts from one station of the production line 100 to another, such as from auxiliary equipment 102 to 3D printer 110a or 110b, or from 3D printer 110a or 110b to auxiliary equipment 120, or from auxiliary equipment 120 to auxiliary equipment 130. Auxiliary equipment 120 and 130 are additional machines for post-processing a printed part, such as modifying the part with auxiliary equipment 120 (depicted as a computer numerical control “CNC” mill) and cleaning the part with auxiliary equipment 130 (depicted as an ultrasonic bath). Auxiliary equipment 150 is a post-processing machine that is used for spinning the part, such as to remove excess resin, coat the part with a customizing material (e.g., to control expansion of the foam material), and/or to create a smooth surface finish. Auxiliary equipment 135 is an expansion equipment (which may also be referred to as a post-processing machine) that is used for controlling expansion of the part. The auxiliary equipment 135 may be, for example, an oven, a light source, an ultrasound generator, pneumatic apparatus, or other type of equipment to apply heat energy, electrical energy, magnetic energy, electrostatic energy, ultrasonic energy, IR light, UV light, vacuum pressure or other types of stimuli for expansion activation. In various embodiments, other types of auxiliary equipment may be included in production line 100 such as for curing, machining, coating, surface finishing, inspection and packaging.

FIGS. 7B and 7C are schematics of spinning apparatuses 151 and 152 that may be utilized as the auxiliary equipment 150 of FIG. 7A. One or more of the spinning apparatuses 151 and/or 152 may be present in a post-processing cell of an additive manufacturing system. FIG. 7B depicts a vertical spinner configuration in which a build tray 153 (also referred to as a print platform) is mounted in an orientation approximately parallel to a top surface 154 of the spinning apparatus 151, with the additively manufactured parts 155 facing downward. The spinning apparatus 151 has a rotation mechanism (not shown) such as a spin motor that rotates the build tray 153 about the axis 156. In this embodiment the build tray 153 is approximately centered on the axis 156, but in other embodiments the build tray 153 may be mounted at a radial distance from the axis 156. In further embodiments, multiple build trays 153 may be included, to be spun around the axis 156. Arrows 157 show a direction of spinning, which is in the clockwise direction in this illustration. In various embodiments the build tray 153 and additively manufactured parts 155 can be spun in multiple directions and/or at different profiles of motions during the spinning process, such as various speeds, accelerations, or multi-step rotations, and in clockwise or counterclockwise directions or combinations thereof (e.g., clockwise followed by counterclockwise or vice versa).

FIG. 7C depicts a horizontal spinner configuration in which build trays 153 are mounted approximately perpendicular to axis 156 of the spinning apparatus 152, with the 3D printed (i.e., additively manufactured) parts 155 facing outward. Four build trays 153 are shown in this illustration, but fewer or more build trays 153 may be included such as from one to six or more. The spinning apparatus 152 has a rotation mechanism (not shown) such as a spin motor that rotates the build tray 153 about the axis 156. Arrows 157 show an example direction of spinning, which may involve multiple directions and/or at different profiles of motions as described in relation to FIG. 7B.

In other embodiments of FIGS. 7B and 7C, the build trays 153 may be mounted at other angles relative to the rotation axis 156. Angles of axial rotation may be in the range of, for example 0 to 90 degrees, or 90 to 180 degrees. Rotation parameters can include speed ramp rates, speed deceleration rates, multi-step rotation (e.g., slow spin for a first duration of time followed by a faster spin for a second duration of time) and/or precession of the axis of rotation (i.e., indexing or rotating the axis of rotation in an angular manner, where the rate and/or angle of precession can be modified). The rotation parameter values will depend on part geometry, resin viscosity, and other parameters to provide enough acceleration to achieve the desired amount of centrifugal force for removing resin and creating smooth surface finishes.

Returning to FIG. 7A, in accordance with embodiments of the present disclosure, the 3D printers 110a and 110b and at least one of the auxiliary equipment 102, 105, 120, 130, 135 and 150 each include a sensor (sensors 140a, 140b, 140c, 140d, 140e, 140f, 140g, 140h, 140i, 140j, 140k) that measures or records a parameter of that equipment. The parameters may be, for example, temperature, weight, acceleration, force, position, thermal distribution, geometrical dimension (e.g., to monitor expansion of expandable foams) or viscosity. The location of each sensor 140a-k depends on the parameter being measured or monitored. For instance, sensors 140a and 140f on auxiliary equipment 102 (e.g., CNC mills) may monitor a position of a cutting tool, or a weight or dimensions of the printed part. Sensors 140b, 140e and 140g on auxiliary equipment 105 (e.g., robotic arms or conveying equipment) may monitor movement of different components of the equipment. Sensor 140c on printer 110a may be, for example, a vibration sensor for the printer chassis, and sensor 140d on printer 110b may be a position sensor for the build tray. Auxiliary equipment 130 (e.g., an ultrasonic bath) shows an example of a piece of equipment having more than one sensor. In the embodiment shown, auxiliary equipment 130 has two sensors, sensor 140h for measuring power used and sensor 140i for measuring a temperature of the bath. Sensor 140j on auxiliary equipment 150 may be, for example, a speed or force sensor for measuring rotation speed or centrifugal force. Sensor 140k on auxiliary equipment 135 (i.e., equipment used to perform expansion of the part) may be, for example, an imaging sensor, temperature sensor, pressure sensor, or other type of sensor to monitor the size/dimensions of a printed part as it is being expanded, or to monitor an activation/stimulus for expanding the part.

As shall be discussed in more detail later in this disclosure, the management platform utilizes information from the sensors in conjunction with machine learning algorithms to manage the production line. In operation, the management platform of the present embodiments is in communication with all the machinery of the production line 100 (e.g., 3D printers 110a and 110b; auxiliary equipment 102, 105, 120, 130, 135 and 150; and sensors 140a-j), where the management platform controls operation of and gathers data from all the machinery. The controlling includes scheduling the equipment, providing instructions for processing the part to be made, monitoring and providing feedback on controlling expansion of foam parts (e.g., feedback from sensor 140k on expansion/auxiliary equipment 135), and providing analysis for production and for business-related decisions. The scheduling can include which printers to use and when (including printers at different geographical locations) and can take into consideration aspects such as availability of devices, service agreements with providers, shipping costs and due dates.

The production line 100 can use a management platform as shown in FIG. 8 and described in U.S. Pat. No. 11,054,808. FIG. 8 is a schematic of components of a management platform 300, in accordance with some embodiments. In FIG. 3, a user 310 can be an end customer who is requesting a part to be made or may be an operator in the manufacturing facility. The user 310 or an API 315 creates jobs/tasks 320 based on previous jobs or new jobs. Because of security protocols embedded in the management platform, the job data is specific to the user. For example, a user logging in from a particular company can only see jobs and data that their company created. Jobs/tasks 320 are work that need to be done, where each job can contain one or more tasks. Tasks are steps that need to be performed. For example, a task may be a software step or may cause a specific industrial Internet of things (iIoT) device to perform an action. Machine learning module 360 interacts with jobs/tasks 320, such as to verify and analyze content or to predict wait times, task times, and queue order.

The created jobs/tasks 320 are queued in a database of the management platform 300 to drive the workflow using workflow module 330. The workflow is software definable actions that can be virtually used together to create a complete manufacturing system. Machine learning module 360 may be used with the workflow module 330 to, for example, automatically optimize wait times, balance workloads and optimize content. The workflow module 330 drives iIoT devices 350 with iIoT module 340 through communication subsystem 345, which may be a LAN, a WAN, the Internet, cloud-based communications, wireless communications, or any combination thereof. The iIoT module 340 is an iIoT hub connection endpoint for the iIoT devices 350. iIoT module 340 provides basic services for functions such as application delivery, device settings, task management, logging and real-time notifications. The iIoT devices 350 can either be used individually or as a collection of devices that work together to create a complete manufacturing system. Example iIoT devices 350 include a 3D printing device, sensor device, robotics device (e.g., to move a printed part from one station to another), post-processing device (such as ultrasonic washing machines, ultrasonic knives for removing supports from the printed part, spinning devices for removing excess resin, air knives for drying parts, coordinate measuring machines for inspection, CNC machines for fine finishing, equipment for activating expansion of foam parts), processing device (computing systems for handling and managing large amounts of data associated with the print job), inspection device (e.g., measuring dimensional accuracy and/or part quality of foam parts during and/or after expansion), and notification device. Notification devices may include, for example, light towers, human machine interfaces, audible buzzers, display monitors to display a status, and other devices and/or programs that provide status indications or communications by visual and/or audible means (e.g., lights, displays, emails, texts).

Embodiments include one or more of the workflow module 330, iIoT module 340, and/or communication subsystem 345 controlling (e.g., in an automated fashion) expansion of the printed part, such as through wireless or other electronic communication. For example, the management platform 300 can instruct an expansion equipment (e.g., auxiliary equipment 135 of FIG. 7A) to operate and cause an unexpanded part to expand (e.g., by sending expansion parameters and/or turning on the equipment) when the part has reached a certain location or stage of the production cycle. The expansion can occur within the same manufacturing facility as where the part was additively manufactured or may occur at a downstream location such as in a facility for preparing the parts for sale or for assembly of the part into another product.

Data 370 is gathered from sensors in the iIoT devices 350, e.g., through iIoT module 340. The data 370 can include, for example, performance data, process data and device status. Process data can include information from sensors of the iIoT devices as well as other manufacturing data, such as the number of parts produced, accuracy of foam part expansion compared to modeled predictions, and downtime due to equipment maintenance. Because process data coming back from the iIoT devices 350 can result in large amounts of data, the data may flow into a data lake, repository or database and be kept as needed based on each job/task use case. As one example, parts manufactured for medical or aerospace applications may require the data to be kept for years, while less critical cases may not require any data to be kept once the part has been completed.

Machine learning module 360 analyzes information from jobs/tasks 320, workflow module 330, iIoT module 340 and data 370 to provide instructions to the workflow module 330 and to control operation of the iIoT devices 350 and in particular, to automatically control additive manufacturing machines in the production line. Controlling operation can include changing machine parameters for a manufacturing run, modifying expansion stimuli parameters, and/or scheduling of the equipment in the workflow. The machine learning module 360 uses AI to process and analyze the device data to perform various tasks, such as to detect manufacturing quality issues, predict hardware failures, and provide process traceability. For example, errors that are detected or predicted during a print run by machine learning module 360 can result in the iIoT module 340 instructing a 3D printer to abort a job, thus reducing material waste and unproductive manufacturing time. In another example, trends in part quality deviation that are measured by post-processing devices (e.g., an inspection station) can be recognized by the machine learning module 360 and corrective action can then be formulated for future 3D print jobs. In some embodiments, the AI may process the feedback in conjunction with a historical database of prior feedback, to learn from past production runs.

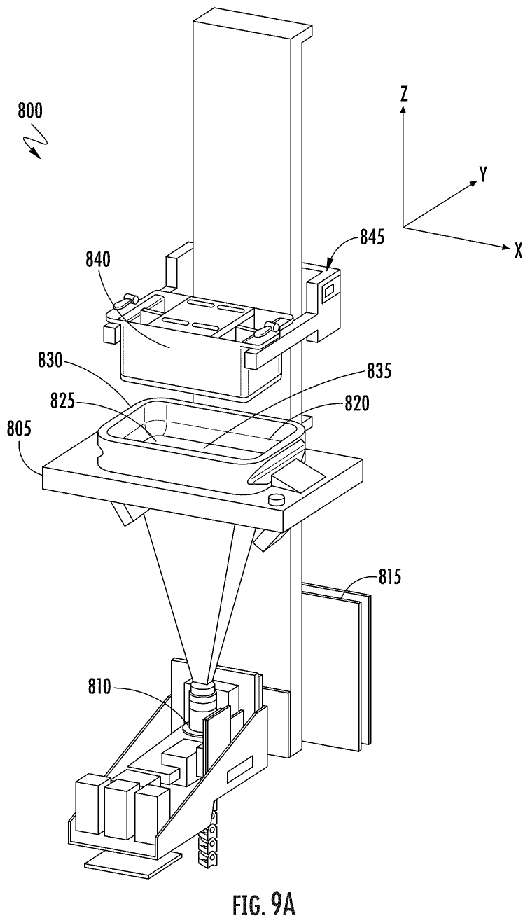

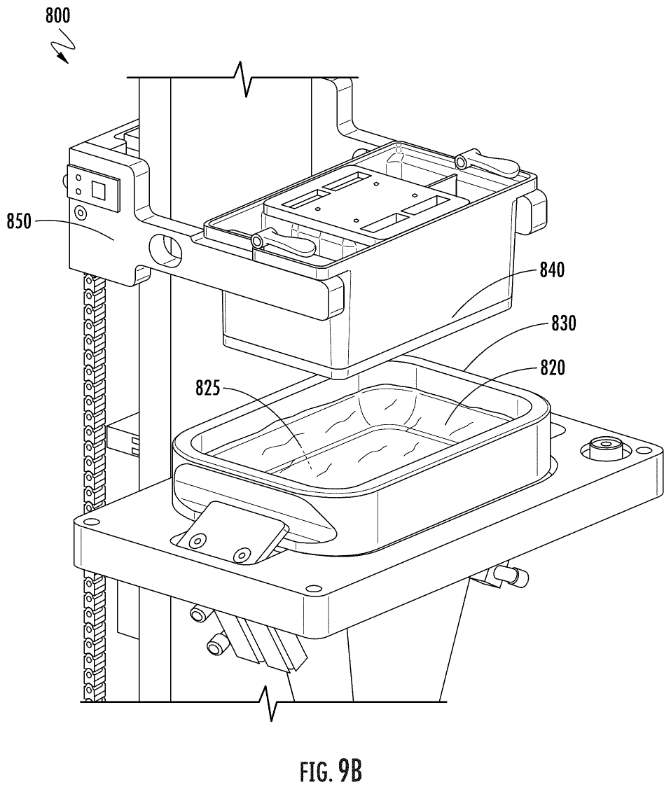

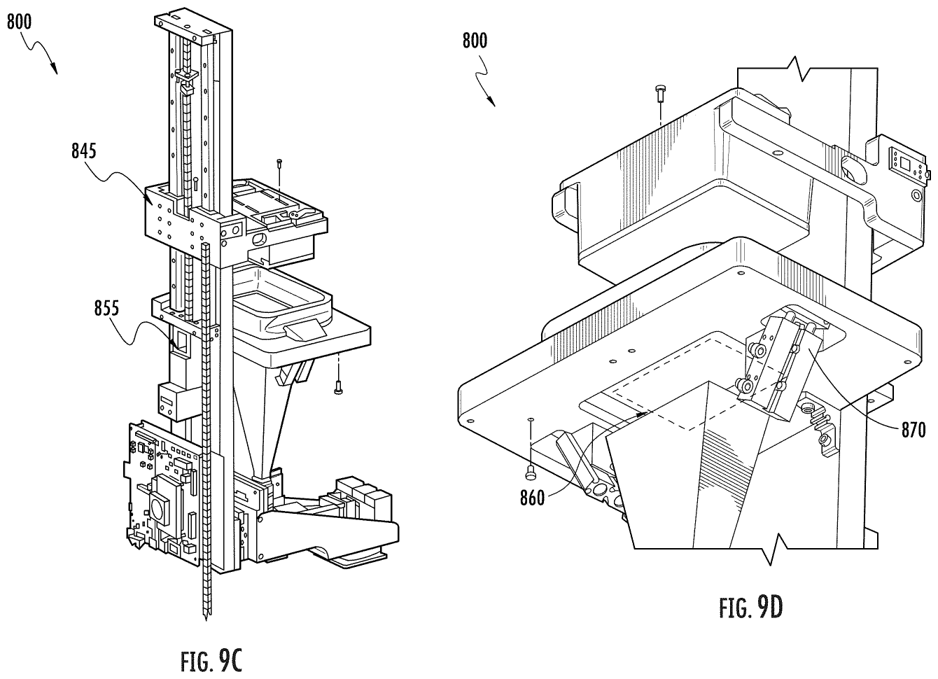

FIGS. 9A, 9B, 9C and 9D illustrate an example of a photoreactive 3D printing system (PRPS) 800, which may be used in conjunction with the present embodiments. The PRPS 800 contains a chassis 805, an illumination system 810, an image display system 815, a resin pool 820, a polymer interface 825, a resin tub 830, a membrane 835, a print platform 840, an elevator system 845, elevator arms 850 (FIG. 9B), a z-stage 855 (FIG. 9C), a membrane tension apparatus 870 (FIG. 9D), and a build area 860. The chassis 805 is a frame to which some of the PRPS components (e.g., the elevator system 845) are attached. In some embodiments, one or more portions of the chassis 805 are oriented vertically, which defines a vertical direction (i.e., a z-direction) along which some of the PRPS components (e.g., the elevator system 845) move. The print platform 840 is connected to the elevator arms 850, which are movably connected to the elevator system 845. The elevator system 845 enables the print platform 840 to move in the z-direction (as shown in FIG. 9A) through the action of the z-stage 855. The print platform 840 can thereby be lowered into the resin pool 820 to support the printed part and lift it out of the resin pool 820 during printing.

The illumination system 810 projects a first image through the membrane 835 into the resin pool 820 that is confined within the resin tub 830. The build area 860 is an area in the resin pool 820 where the resin is exposed (e.g., to ultraviolet light from the illumination system 810) and crosslinks to form a first solid polymer layer on the print platform 840. Some non-limiting examples of resin materials include acrylates, epoxies, methacrylates, urethanes, silicones, vinyls, combinations thereof, or other photoreactive resins that crosslink upon exposure to illumination. The resin may include foaming agents to create expandable foam parts as described herein. In some embodiments, the resin has a relatively short curing time compared to photosensitive resins with average curing times. In other embodiments, the resin is photosensitive to wavelengths of illumination from about 200 nm to about 500 nm, or to wavelengths outside of that range (e.g., greater than 500 nm, or from 500 nm to 1000 nm). In other embodiments, the resin forms a solid with properties after curing that are desirable for the specific object being fabricated, such as desirable mechanical properties (e.g., high fracture strength), desirable optical properties (e.g., high optical transmission in visible wavelengths), or desirable chemical properties (e.g., stable when exposed to moisture). After exposure of the first layer, the print platform 840 moves upwards (i.e., in the positive z-direction), and a second layer can be formed by exposing a second pattern projected from the illumination system 810. This “bottom up” process can then be repeated until the entire object is printed, and the finished object is then lifted out of the resin pool 820.

In some embodiments, the illumination system 810 emits radiant energy (i.e., illumination) over a range of different wavelengths, for example, from 200 nm to 500 nm, or from 500 nm to 1000 nm, or over other wavelength ranges. The illumination system 810 can use any illumination source that is capable of projecting an image (i.e., pattern) for printing the 3D part. Some non-limiting examples of illumination sources are arrays of light emitting diodes, liquid crystal-based projection systems, liquid crystal displays (LCDs), liquid crystal on silicon (LCOS) displays, mercury vapor lamp-based projection systems, digital light processing (DLP) projectors, discrete lasers, and laser projection systems.

In other embodiments, PRPSs can be inverted with respect to the system shown in FIGS. 9A-9D. In such “top down” systems, the illumination source is above the resin pool, the print area is at the upper surface of the resin pool, and the print platform moves down within the resin pool between each printed layer. The additive manufacturing management platforms with closed loop feedback systems described herein are applicable to any PRPS configuration, including inverted systems. In some cases, the sensors, auxiliary equipment or machine learning can be changed to accommodate a different PRPS geometry, without changing the fundamental operation of the systems and methods disclosed herein.

The PRPS 800 (i.e., additive manufacturing machine) is equipped with one or more sensors that monitor various parameters before, during, and after a print run. The information from the sensors can then be used to alter the printing process during the print run or for future print runs. Closed loop operation, as described by the systems and methods herein, can be beneficial for a variety of reasons, including improved print quality (e.g., printed object structural integrity, foam expansion of the part and object surface roughness), print run duration, and equipment longevity. Manufacturing efficiency and cost effectiveness of the system, as well as system maintenance and serviceability, can also be improved using the systems and methods described herein.

In some embodiments, two or more sensors are integrated in a closed loop feedback system in a production line involving a PRPS, to provide information to adjust parameters of a print run in situ. The relationships between different input parameters (e.g., illumination energy, membrane tension, and print platform movement) and output parameters (e.g., local resin temperature, and force experienced by the print platform during movement) in conjunction with sensor information from auxiliary equipment on the production line are complex, and in many cases not obvious. For example, information from two or more of the following sensors can be used together: z-stage position, direction, and velocity, resin bulk temperature, resin tub down force, resin tub vertical displacement, and elevator arm load sensor. Using the systems and methods described herein, complex interactions between multiple parameters can be measured and accounted for during a print run or in future print runs, resulting in higher quality printed objects.

In some embodiments, a print recipe is used by the PRPS. The print recipe contains information for each layer in a 3D printed part to be built by the PRPS. The job for the part contains the content, print recipe and workflow to apply, and the print recipe is created in the workflow from the 3D content input by a user or API. The print recipe can contain instructions for the PRPS before, during and after a print run. For example, the print recipe can include parameters and instructions related to build geometry, illumination energy, exposure time per layer, wait time between layers, print platform position, print platform velocity, print platform acceleration, resin tub position, resin tub force, resin chemical reactivity, resin viscosity, and selective printing (within a layer or layer to layer) of customizing materials for mechanical properties and/or foam expansion. In conventional systems, the print recipe is pre-determined before a print run and is static and does not change during the print run. In the embodiments described herein, the print recipe can be updated before, during and/or after the print run. For example, the parameters and/or instructions contained within the print recipe can be updated before, during and/or after the print run based on input from one or more sensors in the additive manufacturing production line. In some embodiments, the print recipe can be updated before, during and/or after the printing of a given layer within the printed object.

In some embodiments the PRPS can include a resin tub (830, FIGS. 9A and 9B) having a unique membrane tensioning system (870, FIG. 9D) with resin tub vertical displacement sensors, which can be used in closed loop feedback systems. The membrane tension can be adjusted at any point during or between prints, where the adjustment can be made automatically in response to feedback information from one or more sensors. The desired level of membrane tension can be based on, for example, material properties of the membrane, print speed, system construction (e.g., if membrane is supported from below or not), resin viscosity, feedback from auxiliary equipment (e.g., measurements at an inspection station) and/or print specifications (e.g., tolerance ranges of the printed part).

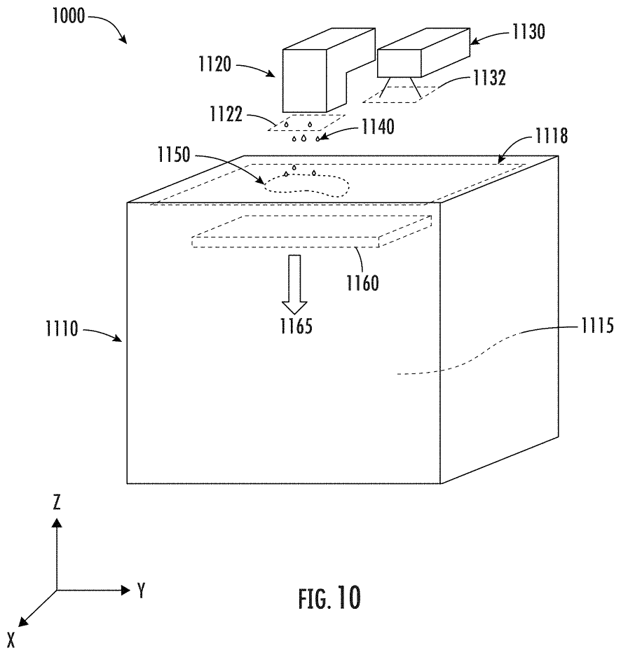

FIG. 10 is an isometric view of an additive manufacturing system as described in U.S. Pat. No. 11,110,650, which may be used in embodiments of the present disclosure. The system combines a vat-based format with dispensing of additional materials onto the vat material that fills the vat. A vat material contained in the vat shall also be referred to as a first composition. A dispensing system such as a jetting head used in inkjet printing dispenses a material onto the vat material, where the dispensed material shall be referred to as a second composition. The materials in the vat and being dispensed may also be referred to as compositions, substances, reactants, and components. Also, the dispensing of material will primarily be described in terms of inkjet dispensing (jetting). However, other types of dispensing techniques are also applicable.

Conventional photoreactive resins are made of monomer, oligomer, photoinitiator, and other materials, where a key ingredient that makes the resin polymerize and sensitive to light is the photoinitiator. In some embodiments of FIG. 10, a first composition 1115 held in a vat 1110 is a resin base material (which may also be referred to in this disclosure as a base resin), where the resin base material is absent of a reactant such as a photoinitiator. That is, the base resin is a composition of substances that will be polymerized into a hardened part but lacking a component that would allow the polymerization to occur. In some embodiments, the first composition comprises a thiol or an -ene, and the second composition comprises the -ene or the thiol, respectively. That is, the first composition comprises a thiol and the second composition comprises an -ene, or the first composition comprises an -ene and the second composition comprises a thiol. Other combinations of materials may be used for the first composition and the second composition, such as various polymer reactants for the first composition and the second composition, where additives may be included in the first composition and/or the second composition. A dispensing head 1120 (e.g., inkjet printing head, syringe/pump-type or other) precisely dispenses photoinitiator (or other reactant) in liquid form as a second composition 1140 onto a top surface 1118 of resin base material in the vat 1110. A foaming agent, foam expansion accelerant, foam expansion activator, or foam expansion inhibitor can be included in the first composition 1115 in the vat or may be in the second composition 1140 dispensed by dispensing head 1120.

In the embodiment of FIG. 10, the dispensing head 1120 has a dispensing area 1122 that covers only a portion of a width (Y-direction) and a portion of a length (X-direction) of the top surface 1118. Consequently, the dispensing head 1120 may dispense the photoinitiator (or other reactant and/or foaming agent) over the entire top surface 1118 by moving in, for example, a raster pattern (e.g., moving the head side to side in the X-direction to form lines, progressing from top to bottom in the Y-direction). The shape 1150 formed by where the photoinitiator droplets were dispensed is the pattern area of a layer of the additive manufacturing part being printed. The additive manufacturing part is formed on a build platform 1160 which is submerged in the vat 1110. The build platform 1160 is adjacent to and underneath the top surface of the resin base when the initial layer of a part is being made, and moves down (negative Z-direction) into the first composition 1115 as subsequent layers are continued to be formed. For clarity, the components illustrated in this figure may not necessarily be drawn to scale. For example, in FIG. 10 the distance between the platform 1160 to the top surface 1118 and the distance between the dispensing head 1120 from the top surface 1118 are larger than what actually may be used.

The resin material and dispensed photoinitiator are then exposed to a wavelength of light from an illumination source 1130, which causes polymerization in selective areas constrained to where the photoinitiator is present. The polymerized layer adheres to the build platform 1160 as in known vat-based processes. The illumination source 1130 may be a UV light source or any other source that produces curing wavelengths that are reactive with the photoinitiator and base resin. For example, in some embodiments, the resin may be photosensitive to wavelengths of illumination from about 200 nm to about 500 nm, or to wavelengths outside of that range (e.g., greater than 500 nm, or from 500 nm to 1000 nm). In the embodiment shown in FIG. 10, the illumination source 1130 emits light having an area 1132 at least similar in size to or greater than the size of the dispensing area 1122 of the dispensing head 1120. The illumination source 1130 may emit light in a pass subsequent to the jetting head, where the illumination source 1130 is moved by a mechanism separate from a mechanism that moves the dispensing head 1120. Alternatively, the illumination source 1130 may be moved simultaneously with the dispensing head 1120, such as by having the illumination source 1130 attached to the same movement mechanism as the dispensing head 1120.

Other embodiments of FIG. 10 may use alternative illumination sources, dispensing heads, materials for the dispensed composition and vat compositions, and techniques for customizing properties within the printed part. For example, the illumination source may be configured to illuminate an area as large as the entire top surface area of the vat, to expose the entire top surface of the first composition (e.g., resin) to light at one time (e.g., a blanket exposure). In other examples, more than one type of light source may be utilized, where one light source moves with the dispensing head and the other is stationary. The multiple light sources can be activated at different times from each other, such as one light source being activated before, during or after the activation of another light source.

Embodiments of manufacturing expanding foam pieces may use vat-based additive manufacturing techniques in which certain materials are selectively dispensed onto the top surface of a liquid substance in the vat. The vat is a tank or tub that is used to hold liquid. Embodiments provide on-demand delivery systems for dispensing materials such that reactants/components come into contact with each other in the vat to form additive manufactured parts. In some embodiments, a substance is dispensed on the surface of a photopolymerizable content that is in the vat, selectively promoting polymerization only in the areas where the substance is delivered. The dispensed substance may be a reaction activator such as a photoinitiator solution that is precisely added into the vat material, where the vat material does not include a photoinitiator. After being dispensed in the vat, the photoinitiator absorbs a polymerization actuation energy such as ultraviolet (UV) light, such that the material is cured only where the photoinitiator is present. In some embodiments, a first reactant of a chemical reaction can be used as the vat material and a second part that will react with the first part for polymerization (e.g., in the presence of UV light) can be dispensed. In some embodiments, foaming agents, foam expansion accelerants or foam expansion inhibitors can be included in the vat material or dispensed onto the vat material.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method of creating additive manufactured parts from expanding foam material, the method comprising:
printing a part made of an expandable foam, using an additive manufacturing system, wherein the expandable foam is printed in an unexpanded state and has a closed layer at an external surface of the part; and
controlling expansion of the part, using the additive manufacturing system, wherein the controlling of the expansion is performed after the printing.

2. The method of claim 1, wherein the closed layer comprises a closed-cell foam after the expansion.

3. The method of claim 1, wherein the external surface comprises all surfaces of the part that are exposed to an ambient environment.

4. The method of claim 1, wherein the expandable foam comprises a foaming agent in a photoreactive resin.

5. The method of claim 4, wherein the foaming agent comprises particles containing a gas, and wherein the controlling comprises expanding the gas during the expansion of the part.

6. The method of claim 1, further comprising dipping the part in a coating material, after the printing and before the controlling of the expansion.

7. The method of claim 6, wherein the dipping creates the closed layer.

8. The method of claim 1, further comprising spinning the part on a spinning apparatus after the printing, to coat the part with an expansion accelerant, an expansion activator, or an expansion inhibitor.

9. The method of claim 1, wherein the printing further comprises printing a customizing material that customizes a property in the part, wherein the customizing material is printed in a designated region of a layer of the part.

10. The method of claim 9, wherein the property is a mechanical property.

11. The method of claim 9, wherein the customizing material is an activator or inhibitor for the controlling of the expansion.

12. The method of claim 1, wherein:
the controlling uses a stimulus to activate the expansion of the part after the printing; and
the controlling comprises monitoring and adjusting the stimulus to control a rate of the expansion of the part.

13. The method of claim 12, wherein:
the stimulus is at least one of a vacuum, an additive, an activator, or energy from an energy source; and
the energy comprises heat energy, electrical energy, magnetic energy, electrostatic energy, ultrasonic energy, infrared light, or ultraviolet light.

14. The method of claim 1, wherein:
the additive manufacturing system is an automated system comprising an additive manufacturing machine, an expansion equipment for performing the expansion of the part, and sensors on the additive manufacturing machine and the expansion equipment; and
the sensors provide feedback during the controlling of the expansion.

15. The method of claim 1, further comprising modeling the expansion before the printing, wherein the modeling is performed by the additive manufacturing system.

16. The method of claim 15, wherein the modeling comprises non-isometric expansion to achieve desired final part dimensions.

17. A method of creating additive manufactured parts from expanding foam material, the method comprising:
modeling an expansion of a part made of an expandable foam; and
printing the part made of the expandable foam according to the modeling, using an automated additive manufacturing system, wherein the expandable foam is printed in an unexpanded state and has a closed layer at an external surface of the part.

18. The method of claim 17, wherein the closed layer comprises a closed-cell foam that remains closed after the expansion.

19. The method of claim 17, wherein the external surface comprises all surfaces of the part that are exposed to an ambient environment.

20. The method of claim 17, wherein the expandable foam comprises a foaming agent in a photoreactive resin.

21. The method of claim 20, wherein the foaming agent comprises particles containing a gas, and wherein the modeling comprises modeling expansion of the gas during the expansion of the part.

22. The method of claim 17, wherein the modeling comprises modeling a stimulus to activate the expansion after the part is installed for use.

23. The method of claim 17, further comprising applying, by the automated additive manufacturing system, a stimulus to expand the part to an expanded state.

24. The method of claim 23, wherein:
the stimulus is at least one of a vacuum, an additive, an activator, or energy from an energy source; and
the energy comprises heat energy, electrical energy, magnetic energy, electrostatic energy, ultrasonic energy, infrared light, or ultraviolet light.
